(19) United States
(12) Patent Application Publication
(10) Pub. No.: US 2011/0302839 A1
(43) Pub. Date: Dec. 15, 2011

(54) PLANT GROWTH SYSTEM AND METHOD USING INDUCTION LIGHTS

(75) Inventors: ERIC SENDERS, Beachwood, OH (US); Cary Senders, University Heights, OH (US); Mathew Geschke, Nuevo, CA (US); T. Stephen Weber, Lyndhurst, OH (US)

(73) Assignee: 6062 Holdings, LLC, Beachwood, OH (US)

(21) Appl. No.: 12/951,824

(22) Filed: Nov. 22, 2010

Related U.S. Application Data
(60) Provisional application No. 61/263,064, filed on Nov. 20, 2009.

(51) Int. Cl. A01G 9/02; A01G 1/00

(52) U.S. Cl. 47/66.6; 47/58.1 LS

(57) ABSTRACT

An apparatus and method for cultivating plant material in an agricultural or horticultural controlled growth environment is provided. The method includes providing a plant material to by cultivated, generating light having a color temperature in the range with an electrodeless induction lamp, and exposing the plant material to the light for a sufficient amount of time to promote the desired plant growth outcome.

### CROSS REFERENCE TO RELATED APPLICATIONS

This application claims the benefit of the filing date under 35 U.S.C. 119(e) of U.S. Provisional Application For Patent Ser. No. 61/263,064 filed on Nov. 20, 2009, which is hereby incorporated by reference.

### TECHNICAL FIELD

The plant growth system and method generally relate to lighting systems that are used in cultivating or growing plants in controlled growth environments.

### BACKGROUND

Controlled plant growth environments such as greenhouses, hydroponic systems, aquaponic systems, indoor gardens, indoor flower beds, and the like, require careful regulation and temperature, light exposure, hydration, nutrients and humidity.

In these controlled plant growth environments, the grower must provide adequate light intensity. This is usually accomplished with the use of a grow light, which is a electric lamp that emits an electromagnetic spectrum that is promotes photosynthesis in the plants. Different types of grow lights may be used in controlled plant growth environments, such as incandescent lamps, fluorescent lamps, high intensity discharge (“HID”) lamps such as high pressure sodium lamps or metal halide lamps, and light emitting diodes (“LEDs”).

### BRIEF DESCRIPTION OF THE DRAWINGS

FIG. 1 is a graph comparing median stem thickness in plants grown under H.I.D. lighting, T5 fluorescent lighting, and induction lighting.

FIG. 2 is a graph comparing canopy leaf surface area in plants grown under H.I.D. lighting, T5 fluorescent lighting, and induction lighting.

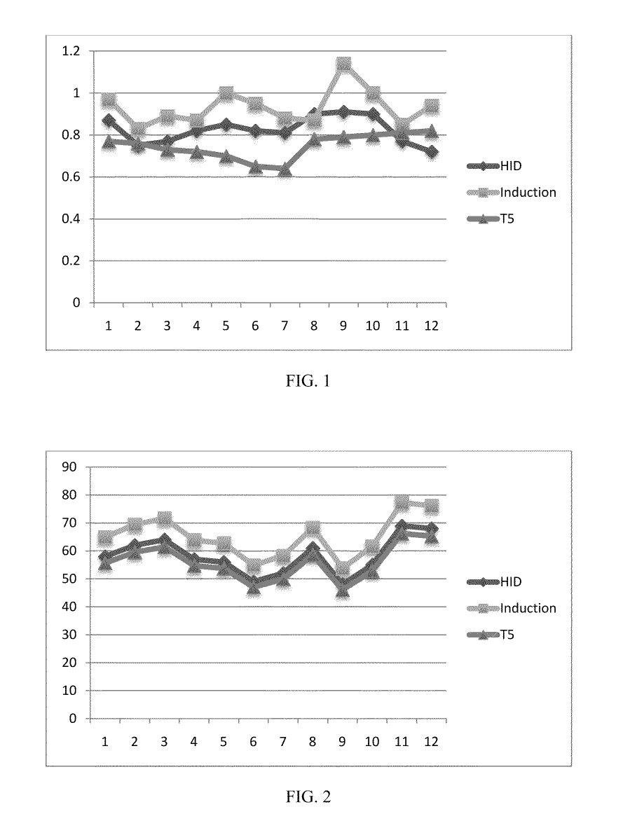

### DETAILED DESCRIPTION

The present method of cultivating plant growth in a controlled growth environment broadly comprises generating light having a desired color temperature with an induction lamp and exposing plant material to said light. Grow trays containing the plant material and plant growth media may be placed in proximity to the induction lamp. The plant material is located at a distance from the induction lamp such that the plant material is exposed to the light generated from the induction lamp. The proximity of the plant material to the induction lamp should not cause thermal or photostress of the plant material.

The method of cultivating plant growth in a controlled growth environment may also comprise contacting plant material with a plant growth medium, generating light having a desired color temperature with an induction lamp, and exposing said plant material to said light.

The method of cultivating plant material in a controlled growth environment may comprise contacting plant material with a nutrient solution, generating light having a desired color temperature with an induction lamp, and exposing said plant material to said light to hydroponically cultivate plant material.

The method of cultivating plant material in a controlled growth environment may comprise contacting plant material with a solution containing plant nutrients and at least one aquatic animal, generating light having a desired color temperature with an induction lamp, and exposing said plant material to said light to aquaponically cultivate plant material.

The method of cultivating plant material in a controlled growth environment may comprise contacting said plant material with a misted nutrient solution, generating light having a desired color temperature with an induction lamp and exposing plant material to said light to aeroponically cultivate plant material in a controlled growth environment.

According to other illustrative embodiments, the method of cultivating plant growth in a controlled growth environment may comprise generating light having a color temperature in the range of from about 2400K to about 5800K with an induction lamp and exposing plant material to said light.

According to other illustrative embodiments, the method of cultivating plant growth in a controlled growth environment may comprise generating light having a color temperature in the range of from about 8500K to about 20,000K with an induction lamp and exposing plant material to said light.

According to further illustrative embodiments, a method of hydroponically cultivating plant growth in a controlled growth environment is provided, the method comprising contacting plant material with a nutrient solution, generating light having a desired color temperature with an induction lamp, and exposing said plant material to said light.

According to other illustrative embodiments, a method of hydroponically cultivating plant growth in a controlled growth environment is provided, the method comprising contacting plant material with a nutrient solution, generating light having a color temperature in the range from about 2,400K to about 5,800K with an induction lamp, and exposing said plant material to said light.

According to other illustrative embodiments, a method of hydroponically cultivating plant growth in a controlled growth environment is provided, the method comprising contacting plant material with a nutrient solution, generating light having a color temperature in the range from about 8500K to about 20,000K with an induction lamp, and exposing said plant material to said light.

According to further illustrative embodiments, a method of aquaponically cultivating plant growth in a controlled growth environment is provided, the method comprising contacting plant material with a solution containing nutrients and one or more aquatic animals, generating light having a desired color temperature with an induction lamp; and exposing said plant material to said light.

According to other illustrative embodiments, a method of aquaponically cultivating plant growth in a controlled growth environment is provided, the method comprising contacting plant material with a solution containing nutrients and aquatic animals, generating light having a color temperature in the range from about 2,400K to about 5,800K with an induction lamp; and exposing said plant material to said light.

According to other illustrative embodiments, a method of aquaponically cultivating plant growth in a controlled growth environment is provided, the method comprising contacting plant material with a solution containing nutrients and aquatic animals, generating light having a color temperature in the range from about 8500K to about 20,000K with an induction lamp; and exposing said plant material to said light.

According to further illustrative embodiments, a method of aeroponically cultivating plant growth in a controlled growth environment is provided, the method comprising contacting plant material with a nutrient solution, generating light having a desired color temperature with an induction lamp; and exposing said plant material to said light.

According to further illustrative embodiments, a method of aeroponically cultivating plant growth in a controlled growth environment is provided, the method comprising contacting plant material with a nutrient solution, generating light having a color temperature in the range from about 2,400K to about 5,800K with an induction lamp; and exposing said plant material to said light.

According to further illustrative embodiments, a method of aeroponically cultivating plant growth in a controlled growth environment is provided, the method comprising contacting plant material with a nutrient solution, generating light having a color temperature in the range from about 8500K to about 20,000K with an induction lamp; and exposing said plant material to said light.

Different spectrums of light are used to support different stages of plant development. The growth of plant material in a controlled growth environment is carried out in the presence of a light that is generated by an induction lamp. The induction lamp is used to generate light having a desired color temperature that is determined by the grower to be appropriate for the given application or stage of growth of the plant material. The method includes generating light with an induction lamp that has a color temperature in the range, for example, without limitation, from about 2400K to about 20,000K, and exposing the plant material to the generated light for a desired period of time. The method may first include contacting plant material with a suitable plant growth medium that is useful for supporting the growth of the plant material, generating light having a desired color temperature with an induction lamp, and exposing the plant material to the generated light for a desired period of time.

The term “induction lamp” as used herein refers to an electrodeless lamp that generates light from power received from outside of the lamp envelope (ie, the lamp bulb) by means of generated electromagnetic fields. Mercury vapor within the lamp envelop is electrically excited to produce ultraviolet light. In turn, the generated ultraviolet light excites phosphors to product the spectrum of light desired for a particular application or phase of growth of the plant material.

The term “plant material” as used herein refers to ungerminated seeds, germinated seeds, seedlings, sprouts, cuttings, shoots, tubers, bulbs, plants, or any part of a plant capable of growth on its own.

The term “contacting” as used herein refers to placing the plant material sufficiently close to the plant growth medium and/or nutrient solution or misted nutrient solution to enable the plant growth medium and/or nutrient solution, or misted nutrient solution to support plant growth. The term “contacting” may include spreading ungerminated seeds or germinated seeds on top of a plant growth medium. Ungerminated seeds, seedlings and plant cuttings can be inserted into holes or slits provided in a plant growth medium. Seedlings and plant cuttings may be suspended within a nutrient solution, or may be suspended in an air environment and exposed to a misted nutrient solution.

According to certain illustrative embodiments, plant material may be grown in a controlled growth environment in traditional grow buckets or grow trays using induction lamp grow light generated light. The method of cultivating plant material includes introducing the plant material to be cultivated into a grow bucket or tray containing a suitable plant growth medium. Without limitation, a suitable plant growth medium may comprise one or more conventional plant media selected from natural soil, soil mixtures, vermiculite, sand, perlite, peat moss, clay, wood bark, coir sawdust, fly ash, pumice, plastic particles, glass wool, rock wool, polyurethane foams, and combinations thereof. The plant material may also be contacted with an artificial plant growth medium comprising a mass of a plurality of polymer fiberballs disclosed in U.S. Pat. Nos. 6,555,219 and 6,397,520, which is commercially available under the trademark SURE TO GROW®. An induction lamp is used to generate light having a desired color temperature to promote plant development, and the plant material is exposed to the generated light for sufficient period of time to promote the desired development of the plant material.

According to additional illustrative embodiments, plant material may be grown hydroponically in a controlled growth environment using induction lamp to provide an appropriate source of grow light. The term “hydroponically” refers to a method for cultivating plant material in a mineral nutrient solution rather than in soil. There are many different versions of hydroponic growth systems, such as, without limitation, deep-water culture, farm-ponic, and flood-and-drain systems, and the present method of using an induction lamp may be utilized in any known hydroponic growing method or system. According to certain illustrative embodiments, a flood-and-drain system is used in combination with one or more induction lamps to hydroponically cultivate plant material. Many plant materials may be cultivated hydroponically with their root systems at least partially submersed in the mineral solution only or in an inert medium that is in contact with the nutrient solution. The method for hydroponically cultivating plant material includes contacting the plant material to be cultivated with a nutrient solution. Alternatively, the plant material to be cultivated may be contacted with a inert medium, such as synthetic polymer growth media, perlite, rock, gravel, or mineral wool and then brought into contact or into fluid communication with the nutrient solution. An induction lamp is used to generate light having a desired color temperature to promote plant growth, and the plant material is exposed to the generated light for sufficient period of time to promote the desired growth and development of the plant material.

According to a further illustrative embodiment, plant material may be cultivated aquaponically using induction lamp to provide an appropriate source of grow light. The term “aquaponically” refers to cultivating plant material and aquatic animals in an integrated, symbiotic system of plants and aquatic animals. Aquatic animals, such as fish, located in an aquaculture digest food and excrete waste into the water of the aquaculture. The waste of the aquatic animals accumulates in the water and provides a nutrient source for the growing plant material. Instead of filtering and disposing, the nutrient-rich water is provided to the plant material. The plant material uptakes the nutrients from the waste water of the aquaculture, thereby reducing the toxic levels of waste in the water. The water is then recirculated to the aquatic animal environment.

The method for aquaponically cultivating plant material includes creating or otherwise establishing a suitable aquaculture that includes at least one aquatic animal, such as fish, and the plant material to be grown. The phrase “at least one aquatic animal” refers to the inclusion of one or more aquatic animals in the aquaculture. The aquaculture may include one or more different species of aquatic animals. The plant material to be cultivated is contacted with the solution of the aquaculture by suspending a portion of the plant material in the solution. Alternatively, the plant material to be cultivated may be contacted with an inert medium, such as synthetic polymer growth media, perlite, rock, gravel, or mineral wool and then plant material/inert medium is brought into contact or into fluid communication with the solution of the aquaculture. An induction lamp is used to generate light having a desired color temperature, and the plant material is exposed to the generated light for sufficient period of time to promote the desired growth and development of the plant material. As the aquatic animals excrete waste products, the water of the aquaculture becomes toxic to the animals, but higher in plant nutrients. This nutrient rich water is delivered to the plant materials and is taken up by the plant material to promote plant growth. The process of taking up the nutrient results in the reduction of the toxicity of the water to the aquatic animals. The water is subsequently returned to the aquatic animals and the cycle continues.

The grower may also wish to utilize induction lamps in the context of the aeroponically cultivating plant material in a controlled growth environment. The method of aeroponically cultivating plant material broadly includes exposing plant material to an air or mist culture or environment, generating light having a desired color temperature with an induction lamp, and exposing the plant material to the generated light to aeroponically cultivate plant material in a controlled growth environment. The plant material is provided with an air or mist environment, rather than traditional soil, an artificial plant growth medium, or other inert growth medium. The plant material may be located within a closed or semi-closed culture or environment and a nutrient rich solution is applied to the plant material by, for example, without limitation, blowing, misting, or spraying the nutrient solution.

### EXPERIMENTAL

An experimental study was carried out to determine the overall efficacy of induction lighting as a viable alternative to traditional H.I.D. lighting used in the propagation of basic hydroponic food crops.

Cucunis sativus was selected for the study as an example of a basic hydroponic food crop. Cucunis sativus seeds were obtained and their average viability noted. Seeds were sown and germinated in darkness for 3 days using traditional germination methods and then subsequently moved to a lighted area. Three lighted areas were established: H.I.D (Metal Halide and High Pressure Sodium Lamps), induction and a control. The control group received only T5 fluorescent light with no supplementation of any kind Plants were grown to maturity as indicated by the cultivars selected. Samples obtained were selected from three different locations on each of the plants sampled. The three areas identified as sample site were the following: canopy, stem and root zone.

Materials: Three different lighting arrays were used in this experimental study. The H.I.D array was designed to simulate the industry accepted lighting method which uses both metal halide H.I.D. lamps as well as high pressure sodium lamps. Plants are traditionally are exposed to 4 weeks of Metal Halide light during vigorous vegetative growth and then placed under High Pressure Sodium light during weeks 5 through maturity for plants that are either harvested for their inflorescence or fruit.

The metal halide lamp used in this trial was a 1000 watt Super Blue by EYE Hortilux® while the high pressure sodium bulb used was a Super HPS manufactured by EYE Hortilux®. Both lamps are considered industry standards and are nearly ubiquitous in their usage in the industry. The induction light selected for this trial was the FSS 400 watt 2700 k I-Light. The T5 lighting array chosen for the control group consisted of an 8 lamp bank manufactured by Hydrofarm™ 5 driven by a Fulham® workhorse ballast producing ˜432 watts. The Kelvin temperature of the T5 bank was approximately 5400 k a spectrum commonly associated with daylight.

Each lighting array was placed into a 4′×4′ Cordura and Mylar lined portable grow space. Each array was hung at an appropriate level for the lighting method used. In each space, a 4′×4′ flood and drain system was located and was populated with 4″×4″ stonewool blocks in which the juvenile plants were placed. Each system employed a flood and drain irrigation method and was supplied with nutrient 4 times a day during the light period. This equates to a 4 hour feeding interval. All plants were irrigated with the same hydroponic nutrient. Nutrient chosen for this trial was General Hydroponics 3 part nutrient and each reservoir was dosed at 1100 ppm during the first 4 weeks and 1250 ppm for the next 6. The reservoir temperature operated within a range of 68-74 degrees F. while the pH ranged between 5.8 and 6.2. Seeds chosen for this trial were of the following variety: Cucunis sativus. Description on the seed packet reads as follows: Though bred for the South, where General Lee is a widely-grown standard, it has also performed well in our Albion trials. Dark fruits with white spines are uniform, attractive and average 8-8½″ long. The gynoecious plants have a high yield potential. 10% pollinator added. Days to maturity or bloom 52. The water used in the preparation of the nutrient solution was processed using a three stage R/O system manufactured by Aqua Engineering with an output value of 7 ppm.

Methods: Twelve plants were placed into each 4′×4′ flood table within each 4′×4′ grow chamber. Each chamber was well ventilated and kept at 72 degrees F. during the day and 68 degrees F. at night. Plants were irrigated 4 times a day during the daylight period and were not irrigated during the night cycle. Lighting arrays were placed at the following heights directly above the canopy: H.I.D lamps were placed at 24″, induction lamp was placed at 16″ and the T5 array was placed at 16″. H.I.D lamps were placed at 24″ inches above the canopy due to the fact that their high thermal output and point source light precludes them from being placed any closer without experiencing thermal or photo stress in the plants. During the first 4 weeks plants received 16 hours of light and 8 hours of darkness. During weeks 6 through harvest plants received 12 hours of daylight and 12 hours of darkness.

Observations were made throughout the growth cycle of the plants, but analyzed data was not collected until harvest. Stem thickness was calculated by taking the average of three sample values obtained at 4″ above the media surface, 8″ above the media surface and 12″ above the media surface. Thickness was determined by means of digital caliper. Canopy surface area was determined by means of LAI.

### Observations:

Week 1&2: Cucumber plants in all three grow locations look healthy and nearly the same height. Plants grown under the H.I.D lighting and induction light were noticeably bushier and exhibit closer juvenile nodal spacing.

Week 3&4: Plants grown under T5 light exhibit noticeably thinner stems and lack the overall vigor and canopy biomass as those grown under H.I.D lighting and induction lamp. Induction samples appear to have better nutrient uptake. This is evidenced by dark green foliar color and overall canopy biomass.

Week 5: Plants transitioned to bloom phase. All plants appear healthy, but plants grown under T5 are noticeably shorter, with thinner stem diameters and smaller leaf surface area.

Week 6&7: Plants grown under H.I.D and induction lighting look similar in stature and canopy density. Plant samples grown under T5 lighting still exhibit lagging behavior. Inflorescence and nodal spacing is regular and density of canopy is superior on the induction samples.

Week 8: All plant samples were harvested for assessment. All plants were cut at media level and their canopies defoliated. Stem thicknesses were obtained and root zones dissected.

After all of the plant samples were harvested and their corresponding values quantified, the data indicates that plants grown under induction light produce 12% more canopy surface area, and 10% more median stem thickness than plants grown under H.I.D lighting and 16% more canopy surface area, 17% and 15% more median stem thickness than plants cultivated under control conditions using T5 fluorescent lighting. Root zone structure was observed and samples taken from all three sites indicated no statistical significance.

Since the induction light operates at a 60% energy savings and two main indicators of overall plant vigor indicate an increase when exposed to induction light, induction lighting as a viable alternative to H.I.D lighting when used in controlled growth environment horticulture.

While the plant growth system and method have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the plant growth system and method should not be limited to any single embodiment, but rather construed in breadth and scope in accordance with the recitation of the appended claims.

1. The present method of cultivating plant growth in a controlled growth environment comprising generating light having a desired color temperature with an induction lamp and exposing plant material to said light.

2. The method of cultivating plant growth in a controlled growth environment of claim 1 comprising:
generating light having a color temperature in the range from about 2400K to about 5800K with an induction lamp; and
exposing said plant material to said light.

3. The method of cultivating plant growth in a controlled growth environment of claim 1 comprising:
generating light having a color temperature in the range from about 2400K to about 2800K with an induction lamp; and
exposing said plant material to said light.

4. The method of cultivating plant growth in a controlled growth environment of claim 1 comprising:
generating light having a color temperature in the range from about 4200K to about 5800K with an induction lamp; and
exposing said plant material to said light.

5. The method of cultivating plant growth in a controlled growth environment of claim 1 comprising:
generating light having a color temperature of about 2800K with an induction lamp; and
exposing said plant material to said light.

6. The method of cultivating plant growth in a controlled growth environment of claim 1 comprising:
generating light having a color temperature in the range from about 8500K to about 20,000K with an induction lamp; and
exposing said plant material to said light.

7. The method of cultivating plant growth in a controlled growth environment of claim 1 comprising:
contacting plant material with a plant growth medium;
generating light having a desired color temperature with an induction lamp; and
exposing said plant material to said light.

8. The method of cultivating plant growth in a controlled growth environment of claim 7 comprising:
contacting plant material with a plant growth medium;
generating light having a desired color temperature in the range from about 2400K to about 5800K with an induction lamp; and
exposing said plant material to said light.

9. The method of cultivating plant growth in a controlled growth environment of claim 7 comprising:
contacting plant material with a plant growth medium;
generating light having a color temperature in the range from about 2,400K to about 2,800K with an induction lamp; and
exposing said plant material to said light.

10. The method of cultivating plant growth in a controlled growth environment of claim 7 comprising:
contacting plant material with a plant growth medium;
generating light having a color temperature of about 2,800K with an induction lamp; and
exposing said plant material to said light.

11. The method of cultivating plant growth in a controlled growth environment of claim 7 comprising:
contacting plant material with a plant growth medium;
generating light having a color temperature in the range from about 4,200K to about 5,800K with an induction lamp; and
exposing said plant material to said light.

12. The method of cultivating plant growth in a controlled growth environment of claim 7 comprising:
generating light having a color temperature in the range from about 8500K to about 20,000K with an induction lamp; and
exposing said plant material to said light.

13. The method of cultivating plant growth in a controlled growth environment of claim 7, wherein said contacting plant material with a plant growth medium comprising contacting an ungerminated seed with said plant growth medium.

14. The method of cultivating plant growth in a controlled growth environment of claim 7, wherein said contacting plant material with a plant growth medium comprising contacting a germinated seedling with said plant growth medium.

15. The method of cultivating plant growth in a controlled growth environment of claim 7, wherein said contacting plant material with a plant growth medium comprising contacting a germinated seedling and the plant medium in which the seedling is growing with said plant growth medium.

16. The method of cultivating plant growth in a controlled growth environment of claim 7, wherein said contacting plant material with a plant growth medium comprising contacting a plant cutting with said plant growth medium.

17. A method of cultivating plant growth in a controlled growth environment comprising:
contacting plant material with a nutrient solution;
generating light having a desired color temperature with an induction lamp; and
exposing said plant material to said light.

18. The method of cultivating plant growth in a controlled growth environment of claim 17, comprising contacting said plant material with a substantially inert plant growth medium.

19. The method of cultivating plant growth in a controlled growth environment of claim 17 comprising:
contacting plant material with a nutrient solution;
generating light having a color temperature in the range from about 2400K to about 5800K with an induction lamp; and
exposing said plant material to said light.

20. The method of cultivating plant growth in a controlled growth environment of claim 17 comprising:
contacting plant material with a plant growth medium;
generating light having a color temperature in the range from about 2,400K to about 2,800K with an induction lamp; and
exposing said plant material to said light.

21. The method of cultivating plant growth in a controlled growth environment of claim 17 comprising:
contacting plant material with a plant growth medium;
generating light having a color temperature of about 2,800K with an induction lamp; and
exposing said plant material to said light.

22. The method of cultivating plant growth in a controlled growth environment of claim 17 comprising:
contacting plant material with a plant growth medium;
generating light having a color temperature in the range from about 4,200K to about 5,800K with an induction lamp; and
exposing said plant material to said light.

23. The method of cultivating plant growth in a controlled growth environment of claim 17 comprising:
generating light having a color temperature in the range from about 8500K to about 20,000K with an induction lamp; and
exposing said plant material to said light.

24. The method of cultivating plant growth in a controlled growth environment of claim 17, wherein said contacting plant material with a plant growth medium comprising contacting an ungerminated seed with said plant growth medium.

25. The method of cultivating plant growth in a controlled growth environment of claim 17, wherein said contacting plant material with a plant growth medium comprising contacting a germinated seedling with said plant growth medium.

26. The method of cultivating plant growth in a controlled growth environment of claim 17, wherein said contacting plant material with a plant growth medium comprising contacting a germinated seedling and the plant medium in which the seedling is growing with said plant growth medium.

27. The method of cultivating plant growth in a controlled growth environment of claim 17, wherein said contacting plant material with a plant growth medium comprising contacting a plant cutting with said plant growth medium.

28. The method of cultivating plant growth in a controlled growth environment of claim 17 comprising:
contacting plant material with a solution comprising plant nutrients and at least one aquatic animal;
generating light having a desired color temperature with an induction lamp; and
exposing said plant material to said light.

29. The method of cultivating plant growth in a controlled growth environment of claim 28, comprising contacting said plant material with a substantially inert plant growth medium.

30. The method of cultivating plant growth in a controlled growth environment of claim 28 comprising:
contacting plant material with a nutrient solution;
generating light having a color temperature in the range from about 2400K to about 5800K with an induction lamp; and
exposing said plant material to said light.

31. The method of cultivating plant growth in a controlled growth environment of claim 28 comprising:
contacting plant material with a plant growth medium;
generating light having a color temperature in the range from about 2,400K to about 2,800K with an induction lamp; and
exposing said plant material to said light.

32. The method of cultivating plant growth in a controlled growth environment of claim 28 comprising:
contacting plant material with a plant growth medium;
generating light having a color temperature of about 2,800K with an induction lamp; and
exposing said plant material to said light.

33. The method of cultivating plant growth in a controlled growth environment of claim 28 comprising:
contacting plant material with a plant growth medium;
generating light having a color temperature in the range from about 4,200K to about 5,800K with an induction lamp; and
exposing said plant material to said light.

34. The method of cultivating plant growth in a controlled growth environment of claim 28 comprising:
contacting plant material with a nutrient solution;
generating light having a color temperature in the range from about 1850K to about 20,000K with an induction lamp; and
exposing said plant material to said light.

35. The method of cultivating plant growth in a controlled growth environment of claim 28, wherein said contacting plant material with a plant growth medium comprising contacting an ungerminated seed with said plant growth medium.

36. The method of cultivating plant growth in a controlled growth environment of claim 28 wherein said contacting plant material with a plant growth medium comprising contacting a germinated seedling with said plant growth medium.

37. The method of cultivating plant growth in a controlled growth environment of claim 28, wherein said contacting plant material with a plant growth medium comprising contacting a germinated seedling and the plant medium in which the seedling is growing with said plant growth medium.

38. The method of cultivating plant growth in a controlled growth environment of claim 28, wherein said contacting plant material with a plant growth medium comprising contacting a plant cutting with said plant growth medium.

39. The method of cultivating plant growth in a controlled growth environment of claim 17 comprising:
contacting plant material with a nutrient solution by misting the nutrient solution onto the plant material;
generating light with an induction-type lamp having a desired color temperature; and
exposing said plant material to said generated light.

40. The method of cultivating plant growth in a controlled growth environment of claim 39 comprising:
contacting plant material with a nutrient solution;
generating light having a color temperature in the range from about 2400K to about 5800K with an induction lamp; and
exposing said plant material to said light.

41. The method of cultivating plant growth in a controlled growth environment of claim 39 comprising:
contacting plant material with a misted nutrient solution;
generating light with an induction-type lamp having a color temperature in the range from about 2,400K to about 2,800K; and
exposing said plant material to said generated light.

42. The method of cultivating plant growth in a controlled growth environment of claim 39 comprising:
contacting plant material with a misted nutrient solution;
generating light with an induction-type lamp having a color temperature of about 2,800K; and
exposing said plant material to said generated light.

43. The method of cultivating plant growth in a controlled growth environment of claim 39 comprising:
contacting plant material with a misted nutrient solution;
generating light with an induction-type lamp having a color temperature in the range from about 4,200K to about 5,800K; and
exposing said plant material to said generated light.

44. The method of cultivating plant growth in a controlled growth environment of claim 39 comprising:
contacting plant material with a nutrient solution;
generating light having a color temperature in the range from about 8500K to about 20,000K with an induction lamp; and
exposing said plant material to said light.

45. The method of cultivating plant growth in a controlled growth environment of claim 39, wherein said plant material comprises ungerminated seeds.

46. The method of cultivating plant growth in a controlled growth environment of claim 39, wherein said plant material comprises a germinated seedling.

47. The method of cultivating plant growth in a controlled growth environment of claim 39, wherein said plant material comprises a plant cutting.

48. A plant growth system comprising:
a grow container or chamber for holding plant material and optionally plant growth media; and
at least one induction-type lamp capable of generating light having a color temperature in the range from about 2400K to about 20,000K.
